(19) United States
(12) Patent Application Publication
(10) Pub. No.: US 2005/0078606 A1
(43) Pub. Date: Apr. 14, 2005

(54) Pattern-based correlation of non-translative network segments

(76) Inventors: David R. Bernstein, Scotts Valley, CA (US); Robert W. Otis, San Jose, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/940,385

(22) Filed: Sep. 13, 2004

Related U.S. Application Data
(60) Provisional application No. 60/502,011, filed on Sep. 11, 2003.
(60) Provisional application No. 60/502,020, filed on Sep. 11, 2003.

(51) Int. Cl. H04L 12/26

(52) U.S. Cl. 370/241

(57) ABSTRACT

Methods and systems for correlating network traffic between non-translative network systems are provided. Generally, protocol cause and effect correlation rules are determined between devices in non-translative network segments by injecting a known network pattern at a first end of the network topology. Traces of the network traffic are then recorded over one or more nodes throughout the non-translative network. The generated network traffic is then compared to the traced network traffic by pattern matching to thereby determine protocol cause and effect correlation rules. Later, when it is desired to determine causality of network activity between non-translative network segments, the traced network patterns can be compared by pattern matching to the protocol cause and effect correlation rules to assist in determining the origin of a network operation that created an observed event.

### CROSS-REFERENCE TO RELATED APPLICATIONS

This application claims the benefit of Provisional Application No. 60/502,011, filed Sep. 11, 2003, and Provisional Application No. 60/502,020, filed Sep. 11, 2003, both of which are incorporated herein by reference.

### BACKGROUND OF THE INVENTION

1. The Field of the Invention

The present invention relates to systems and methods for pattern-based correlation of non-translative network segments. More particularly, the present invention provides for a causal correlation to be determined, using pattern-based methods of identifying typical cause effect network activity, between network activities occurring in network segments that operate in differing network protocols.

2. The Relevant Technology

Computer and data communications networks continue to develop and expand due to declining costs, improved performance of computer and networking equipment, and increasing demand for communication bandwidth. Communications networks, including for example, wide area networks (“WANs”), local area networks (“LANs”), and storage area networks (“SANs”) allow increased productivity and utilization of distributed computers or stations through the sharing of resources, the transfer of voice and data, and the processing of voice, data, and related information at the most efficient locations. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of installed networks.

In a protocol-homogeneous networking environment, with a sufficiently detailed understanding of the networking protocols in use, a network engineer can correlate a network request from a particular endpoint, to particular traffic patterns along the transit path, through various traffic control points such as switches or routers, and to the one or more target destinations for that original network request. For example, in the case of a TCP/IP network, depending on how the Address Resolution Protocol (ARP) is used, the source and destination MAC (physical) addresses are available in the network transmission itself. And so as the packet traverses across a network topology, it can be correlated to the packet which traversed a previous segment of the topology. At a higher level, using IP addresses and test pings, there are utilities which discover and display network segments, such as “traceroutes,” illustrating this point.

As the demand for networks has grown, however, network technology has grown to include many different physical configurations. As an example, an enterprise may employ a communications system that uses five different data communications protocols, which set forth the rules for accessing the network and the communications primitives amongst the resources on the network, each adapted for a particular situation. Such protocols may include: a first protocol for a high speed, inexpensive short-haul connection on the computer motherboard; a second high-bandwidth protocol for data center transmissions across for example fiber optic cables; a third protocol that is suited for efficiently transmitting information across the enterprise local area network (“LAN”) across for example electrical cables; a fourth protocol adapted for high bandwidth, long haul applications across for example fiber optic cables or microwave links; and, finally, a fifth transmission protocol suited for data transmission to high performance disk drive storage systems at a storage area network (“SAN”) across for example fiber optic cables. Thus, the typical communications system comprises a patchwork of different subsystems and associated communications protocols. More specific examples include: TCP/IP, Gigabit Ethernet, Asynchronous Transfer Mode (“ATM”), Synchronous Optical Network (“SONET”), Fiber Distributed Data Interface (“FDDI”), Fibre Channel, and InfiniBand networks. These and the many other types of networks that have been developed typically utilize different cabling systems, different bandwidths and typically transmit data at different speeds.

In a non-homogeneous network, many network topologies consist of segments which have different physical media, or different underlying protocol. However, through encapsulation, tunneling, or protocols-on-top-of-protocols, one can identify a common software protocol through the entire topology. For example, it is common to interconnect ATM networks running a layered TCP/IP Point to Point Protocol (“PPP”) on top of them, to a router which then connects to a native, TCP/IP network on Ethernet. In this way the ATM and Ethernet networks share a homogenous TCP/IP protocol across them.

If the network is not homogenous at some protocol level, correlation of network traffic across these segments is challenging. For example, a mixed data network utilizing TCP/IP protocol and a Storage Array Network (SAN), utilizing Fiber Channel (“FC”) protocols, can be problematic. Traffic on the TCP/IP network destined to cause a resultant conversation with the data storage subsystem connected to the SAN would be translated by software and firmware in intermediate servers into FC-based SAN protocol. The addressing scheme, the state transitions, timing, and routing/switching conventions in SANs are completely different than in TCP/IP systems, and thus there is no straightforward way to correlate packets or activity on the SAN network with the TCP/IP network. We call these “non-translative” network segments because there is no way to directly translate traffic and traffic patterns in one network segment into traffic and traffic patterns in another.

As communication networks have increased in number, size and complexity, therefore, they have become more likely to develop a variety of problems that are increasingly difficult to diagnose and resolve. Moreover, the demands for network operational reliability and increased network capacity, for example, emphasize the need for adequate diagnostic and remedial systems, methods and devices.

Exemplary causes of network performance problems include the transmission of unnecessarily small frames of information, inefficient or incorrect routing of information, and improper network configuration and superfluous network traffic, to name just a few. Such problems are aggravated by the fact that many networks are continually changing and evolving due to growth, reconfiguration and introduction of new network typologies and protocols, as well as the use of new interconnection devices and software applications.

Consequently, as high speed data communications mature, many designs increasingly focus on reliability and performance issues. In particular, communications systems have been designed to respond to a variety of network errors and problems, thereby minimizing the occurrence of network failures and downtimes. In addition, equipment, systems and methods have been developed that allow for the testing and monitoring of the ability of a communications system to respond to and deal with specific types of error conditions on a network. In general, such equipment, systems, and methods provide the ability to selectively alter channel data, including the introduction of errors into channel data paths.

Using network analysis tools, network administrators can identify and resolve various types of network problems. In some situations, network problems may be resolved by sampling a portion of the data transmitted across the network or by performing a statistical analysis on portions of the transmitted data. Other solutions require the collection of all data that traverses the network during a given time period. Collecting all of the data into a capture enables a network administrator to perform a detailed analysis on the collected data.

Implementation of this functionality on non-translative networks, however, requires that a causal relationship be identified between the data captured by way of the various links. As a result, in networks having non-translative network segments, there is a need for systems and methods to precisely correlate traffic amongst the segments. It would therefore represent an advance in the art of networked communications systems to enable the correlation of traffic between non-translative segments in computing networks.

### BRIEF SUMMARY OF THE INVENTION

The present invention provides methods and systems to correlate two or more connected but non-translative computer and/or storage networks. Conventionally, it has been impossible to understand a cause and effect relationship between non-translative networks because of the difficulties in operating with differing protocols. The present invention derives such cause and effect relationships by creating special traffic packets, patterns, and sets of patterns, injecting them into the various network segments at nodes, and then listening via trace captures in the various network segments at other nodes. A comparison of the traced network activity to the generated network activity allows for the formation of correlation rules which can be used to recognize similar patterns caused by the same activities in the future.

Accordingly, a first example embodiment of the invention is a method for correlating non-translative network segments in a multi-protocol communications system. The method generally includes: providing at least two connected nodes within a network, wherein- a first node is in a non-translative network segment with respect to a second node; at the first node, generating and injecting a defined network pattern into network traffic and recording precisely the time stamp of the network pattern injection; at the second node, listening to network traffic, taking a copy of the traffic passing by as a trace, and adding precise time stamp information to the trace; correlating the generated defined network pattern to the traced traffic; and from the correlation of the generated defined network pattern to the traced traffic, deriving protocol cause and effect correlation rules.

Another example embodiment of the invention is a method for correlating non-translative network segments in a multi-protocol communications system. This method generally includes: providing a plurality of connected nodes within a network, wherein a first node is in a non-translative network segment with respect to a second node; providing pattern matching data which indicates protocol cause and effect correlation rules; at each of the plurality of nodes, listening to network traffic, taking a copy, as a trace, of the traffic passing by; applying a run-time process to the traced traffic using the stored pattern matching tables to recognize correlations; and from the recognized correlations, deriving the causality, in a first network segment, of a network activity that is detected in a second network segment that is non-translative with the first network segment.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a suitable operating environment for practicing the invention in which non-translative network are combined in a single network;

FIG. 2 illustrates the connection between two non-translative networks;

FIG. 3 illustrates graphically the correlation of network traffic according to one embodiment of the invention;

FIG. 4 illustrates a flow chart depicting a method of correlating network traffic according to one embodiment of the invention; and

FIG. 5 illustrates another flow chart depicting a method of correlating network traffic according to another embodiment of the invention.

### DETAILED DESCRIPTION OF THE PREFERRED EMBODIMENTS

The present invention provides a way to correlate two or more connected but non-translative computer and/or storage networks. As used herein, the term “non-translative networks” refers to networks which do not have a common protocol across them. Conventionally, it has been impossible to understand a cause and effect relationship between non-translative networks. The present invention derives such a traffic relationship by creating special traffic packets, patterns, and sets of patterns, injecting them in to the various network segments at nodes, and then listening via trace captures in the various network segments at other nodes. A comparison of the traced network activity to the generated network activity allows for the formation of correlation rules which can be used to recognize similar patterns caused by the same activities in the future.

As used herein, the term “node” refers to a point in a communications network where two or more communication paths come together in a device, such as by way of example only, a switch, a server, a network analyzer, a computer, or an external device such as a network probe.

The invention takes advantages of the cause and effect relationship in traffic patterns across non-translative network segments. These patterns are typically only initially discernable only if a single application is the cause of the pattern. In other words, given a set of networking cause patterns {M} from one network segment (e.g., A Windows Network Filesystem on a TCP/IP LAN), one can derive, for each cause-pattern in {M}, typical response patterns {N} from the other network segment (e.g., “a SAN”). Thus there can be correlated a set of {M:N} and {N:M} patterns. These patterns can then be used derive correlation rules than can be used to identify the sources of network activity, particularly problems.

For example, filesystem protocols are often the most relevant to a network analysis, including those of Windows LAN and NFS for UNIX LAN. Depending on the types of operations that are of interest, a developer can determine how to simulate, through generation, the basic network traffic from the LAN side at the TCP or UDP level, for the filesystem operations. Network traffic is then traced in other sections of the network after the simulation is initiated and patterns of network activity are recognized. The network patterns can then be reduced to protocol cause and effect correlation rules, which allow for the identification of network activity such as: list, mount, read, seek, write, open, close, delete, and the like.

Reference will now be made to the drawings to describe various aspects of exemplary embodiments of the invention. It is to be understood that the drawings are diagrammatic and schematic representations of such exemplary embodiments, and are not limiting of the present invention, nor are they necessarily drawn to scale.

In the following description, numerous specific details are set forth in order to provide a thorough understanding of the present invention. It will be obvious, however, to one skilled in the art that the present invention may be practiced without these specific details. In other instances, well-known aspects of network systems have not been described in particular detail in order to avoid unnecessarily obscuring the present invention.

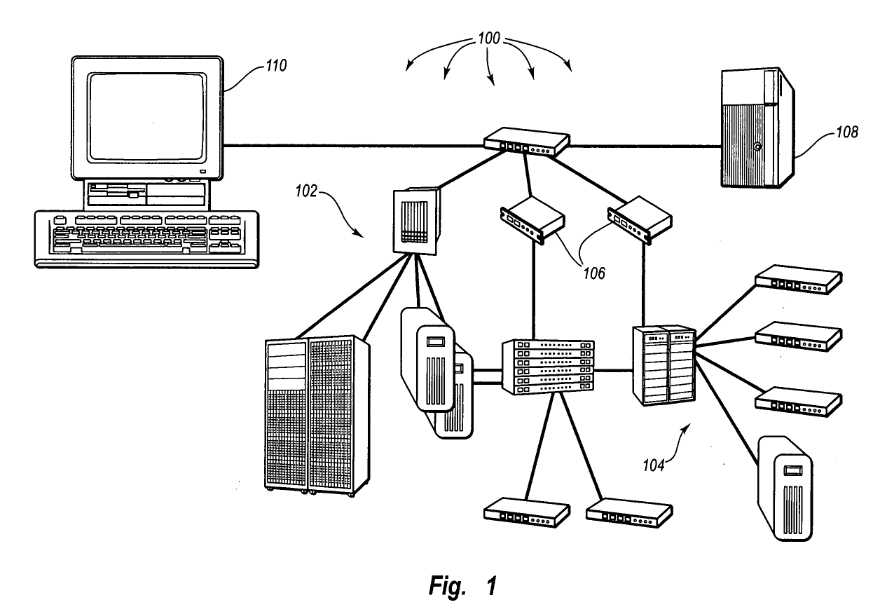

With reference to FIG. 1, an exemplary operating environment in which embodiments of the present invention can be practiced is depcited. Generally, the operating environment includes a non-translative network 100 having both a Fiber Channel SAN network 102 and a TCP/IP LAN network 104. Of course, the non-translative network 100 could also include other network forms such as Wide Area Networks or the Internet and the like or any other combination thereof, including any number of differing protocols. The non-translative network 100 can be either a wired and/or wireless network.

In addition, the non-translative network 100 as depicted includes network probes 106, external server 108, and computer 10. More particularly, each of SAN network 102 and LAN network 104 may have varying degrees of “granularity,” meaning they can have numerous parts and components from many manufacturers, thus complicating the networks and making the task of isolating problems more difficult. As generally depicted, such network parts or components may include, by way of example only, servers, routers, mass storage devices, probes, switches, network analyzers, and other computing devices known in the art or developed hereafter. As a result, the number of parts or components a packet travels through from one end of a network to another may vary greatly within various embodiments of the invention.

In one embodiment, the computer 110 is a network analyzer or similar apparatus for monitoring network data traffic in the communications network 102 in order to detect and diagnose problem conditions existing in the network, such as problem conditions existing between network components or links between components. In various embodiments of the invention, methods as disclosed herein may be coordinated and/or executed by computer 110.

In addition, network probes 106 are inserted external devices that serve to capture traces of network traffic. In one embodiment of the invention, each network segment that is to be correlated is attached to such a probe to capture traces within that network segment.

In preferred embodiments of the invention, there are also generators at one or both ends of the network topology to be correlated. Although the precise definition of “generator” is not critical to the invention, at a minimum a generator will be operable, manually and/or automatically, to generate packets and or network traffic patterns to inject into the network traffic. Probes and generators will also preferably be equipped with some mechanism to record a “time stamp” to record the time at which a given piece of network traffic was either injected into the network or recorded as a trace.

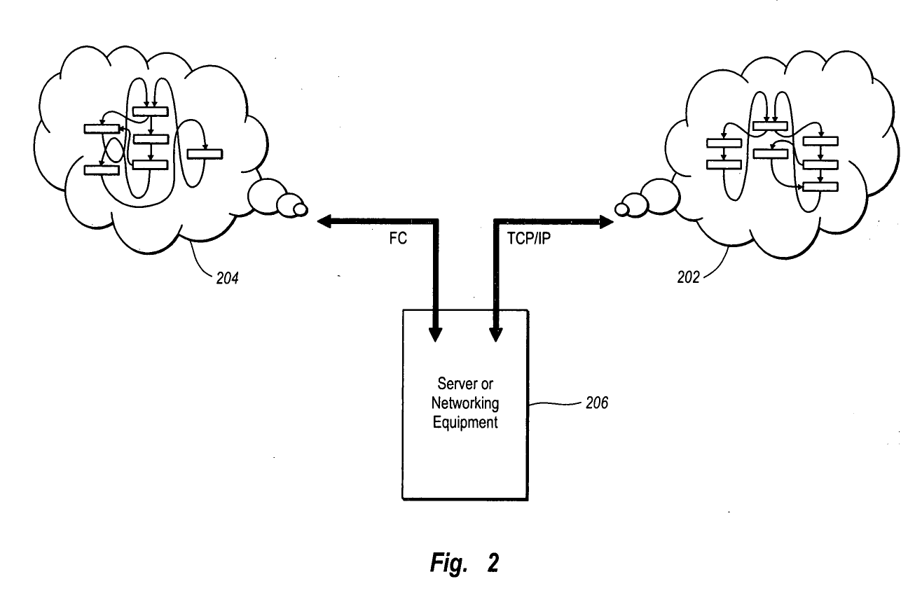

As seen in FIG. 2, a TCP/IP network 202 is connected to a Fibre Channel network 204 by a server or piece of networking equipment 206. In the simplest of examples, requests for data on the TCP/IP network are implemented by the TCP/IP protocol stack in its software or hardware, which is controlled by the state transition programming within the protocol stack. The software and hardware in the server or networking equipment fulfils this request by invoking activity on the Fibre Channel network. The Fibre Channel network is implemented by the Fibre Channel protocol stack in its software or hardware, which is controlled by the state transition programming within the protocol stack. Although the two networks are working on the same problem, there is no direct mapping of packets from one to the other; in other words they are non-translative. The state machines on either network protocol are operating independently.

There is a cause and effect relationship in activity in each network. According to the invention this cause and effect relationship can be tracked through pattern recognitions across non-translative network segments which are working on the same problem. In other words, activity on one network can cause activity on the other network in a recognizable pattern. Each activity in a first network segment will have a respective patterned response it induces at another network segment, and vice versa. According to the invention, these patterned responses can be identified and used to correlate activity across non-translative network segments, thereby helping to identify the source of network problems.

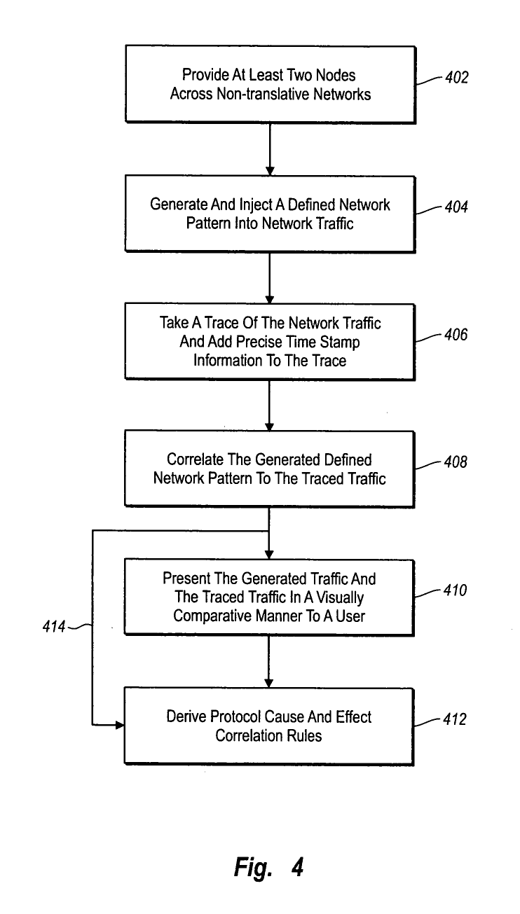

Referring now to FIG. 4, a method of implementing the invention to correlate network traffic across non-translative network segments includes first providing at least two nodes across non-translative network segments, as indicated by box 402. As previously noted, such nodes can include switches, routers, network probes, network analyzers, computers, or other network devices known in the art. In various embodiments of the invention, one or more nodes may be probes used expressly for the purpose of injecting network traffic patterns or recording traces of network traffic according to embodiments of the invention.

Next, network traffic in known stimulus patterns is generated and injected into network traffic, as indicated by block 404. This is preferably performed when the network is “quiet” in that other network traffic is avoided so that network activity can be precisely recorded. It should be noted that the generated and injected stimulus patterns preferably correspond to designated activities, for example: open file, save file, access Internet web site, etc. Thus, the generated and injected stimulus pattern will provide a footprint for how that pattern affects network activity throughout the network. Ideally, the entire process will be repeated, varying only this step, to inject different stimulus patterns and thereby detect and store the response patterns caused by a number of network activities.

Network traffic is next recorded as traces with precise time stamp information, as indicated by block 406. In other words, the corresponding network patterns caused by an initial activity at downstream locations in the network is measured. The process of injection and trace recording can be performed bi-directionally on the topology, e.g., generated from both ends and capture/trace from both ends. In addition, the process can be initiated and executed with any desired degree of manual operation or automation.

The generated traffic patterns and the traced network traffic can then be correlated to match patterns in the generated traffic and the traced traffic, as indicated at block 408.

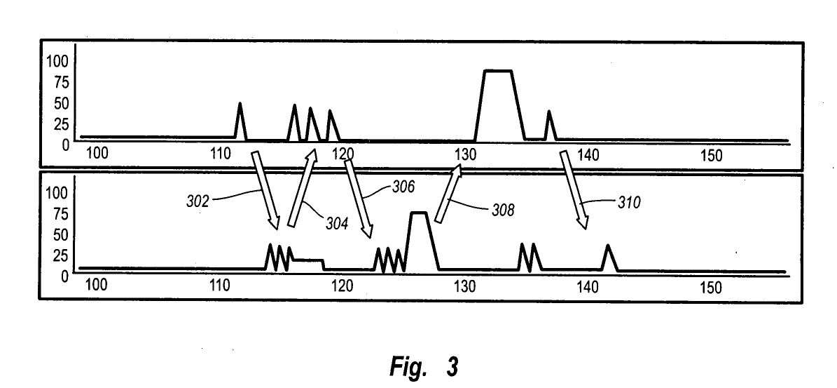

Next, the correlated patterns can optionally be presented visually to a user in a comparative manner in a graphical user interface, as indicated by block 410. For example, shown in FIG. 3 is a visual representation of the network activity in a comparative manner for a user. Depicted is a generated network pattern, or a recorded trace at a first node, in the top graph with a recorded trace at a second node in the bottom graph. Optionally, the recorded trace at the second node and/or the generated network pattern, or recorded trace, at the first node can be correlated, or shifted, to better align the patterns. Time stamp information is presented at the bottom of each graph. As indicated by arrows 302, 304, 306, 308, and 310, patterns can be correlated in the network activity at each of the nodes. Particularly, depicted is an initial request from upper network and the dialog between the two networks, including the fulfillment of data from the lower network to the upper network. In this example, a detected activity at a first node induces a recognized response at the second node, as indicated by arrow 302. Although the patterns are not identical, the performance of these actions in the absence of other network traffic allows confidence in determining the correlation. Similarly, activity is induced back and for the between the nodes as data or instructions are interchanged between the nodes, as indicated by arrows 304, 306, 308, and 310. This graphical correlation can be estimated automatically and then adjusted manually by a user, if desired.

As indicated at block 412, protocol cause and effect correlations rules can then be determined. In one embodiment of the invention, the protocol cause and effect correlations rules can be determined without presenting the graphs visually to a user, as indicated by arrow 414. Such rules can be determined automatically by expert system, statistical or other methods known in the art in conjunction with the computing devices disclosed herein or otherwise known in the at.

One example of a preferred method is called the Time Series Composite Correlation technique. Generally, in this method each network trace is digitized to a common granularity depending on the speed of the network. For networks operating in the gigabit per second range the granularity for digitization should be in the microsecond range. This digitization is called a streaming time series. Each streaming time series contains triple values for each data point: streamID, timeposition, and value. A unit time window is chosen, which is suitably long, by way of non limiting example 1 second. This ensures that a cause and an effect can be held within the same time window. Let s[i] denote the value of the stream s at time position i and s[i . . . j] denote the subsequence of stream s from timeposition i through j inclusive. Let sⁱ denote the stream with the streamID i. Use t to denote the latest timeposition. A strong correlation of any stream pair will be close to −1 for high negative correlations, and close to +1 for high positive correlations, as calculated using the following formula:
corr(s, r)={Σ^{w}ᵢ₌₁sᵢrᵢ−w \check{r} \check{s} }/{(Σ^{w}ᵢ₌₁ sᵢ²−w\check{s}²)^{1/2}(Σ^{w}ᵢ₌₁ rᵢ²−w \check{r}²)^{1/2}}
where \check{r} and \check{s} are the average value of stream r and s, respectively, over the silding window. The correlation term t is derived by applying an application dependent threshold function T on the resultant corr(s, r) yielding a “true” or “false” for correlation term tᵢ. A composite correlation, then, is in the form t₁ [symbol] t₂ [symbol] . . . [symbol] tₙ. A composite correlation pattern can be evaluated at any timeposition and is evaluated to be either true or false at any given timeposition. By adjusting time offsets in the data streams and by running several sets of correlation calculations through multiple time windows, correlations can be discovered across streams, using this algorithm. This algorithm is just one example of many possible algorithms which can be used to determine correlation.

This process can be repeated across various network segments at any desired degree of granularity for any number of activities to determine a database of rules for recognizing network patterns.

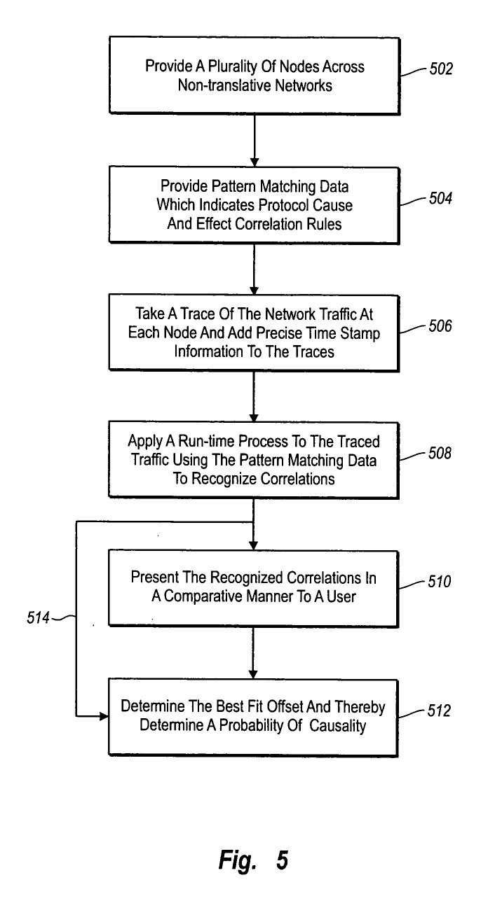

Referring now to FIG. 5, once one or more protocol cause and effect rules have been determined for network activity between networked devices within and between non-translative network segments, the causality of observed network events, including problems, can be determined. Accordingly, the first act in FIG. 5 includes providing a plurality of nodes across non-translative networks, as indicated at block 502. As previously mentioned, a database of pattern matching data and corresponding protocol cause and effect rules are provided, as indicated at block 504. The basic functionality required for the plurality of nodes is the ability to record traces of network traffic, preferably though not necessarily with time stamps. Thus, as network traffic passes through each node, traces are recorded as desired, as indicated by block 506.

The recorded traces at a give node are then correlated with known pattern matching data via run-time processes, as indicated by block 508. Such correlations can be determined automatically by expert system, statistical, streaming time series, or other methods known in the art in conjunction with the computing devices disclosed herein or otherwise known in the art. On example is the Time Series Composite Correlation technique described above. These correlations are optionally presented to a user in a visually comparative manner, as indicated by block 510. From the pattern matches and the protocol cause and effect correlation rules the source of network activity can be determined, as indicated by FIG. 512. As indicated by arrow 514, the act of the presenting the recognized correlation in a comparative manner can be omitted, replaced by an automated process.

Details associated with complementary time-based methods for correlating non-translative network segments are disclosed in U.S. patent application Ser. No. ______ (not yet received), entitled “Time-Based Correlation of Non-Translative Network Segments,” bearing attorney docket No. 15436.343.1, which has been filed on the same day as the present invention and is incorporated herein by reference. The pattern-based methods of this invention can be practiced in combination with or independently from the time-based methods disclosed in the foregoing patent application.

In at least some cases, some or all of the functionality disclosed herein may be implemented in connection with various combinations of computer hardware and software. For example, at least some devices use hard coded devices such as field programmable gate arrays (“FPGA”) to implement pattern generation, injection, trace capture, and data correlation functionality. Other devices employ both hardware and software to implement various functions disclosed herein.

With respect to computing environments and related components, at least some embodiments of the present invention may be implemented in connection with a special purpose or general purpose computer that is adapted for use in connection with communications systems. Embodiments within the scope of the present invention also include computer-readable media for carrying or having computer-executable instructions or electronic content structures stored thereon, and these terms are defined to extend to any such media or instructions for use with devices such as, but not limited to, link analyzers and multi-link protocol analyzers.

By way of example such computer-readable media can comprise RAM, ROM, EEPROM, CD-ROM or other optical disk storage, magnetic disk storage or other magnetic storage devices, or any other medium which can be used to carry or store desired program code in the form of computer-executable instructions or electronic content structures and which can be accessed by a general purpose or special purpose computer, or other computing device.

When information is transferred or provided over a network or another communications connection (either hardwired, wireless, or a combination of hardwired or wireless) to a computer or computing device, the computer or computing device properly views the connection as a computer-readable medium. Thus, any such a connection is properly termed a computer-readable medium. Combinations of the above should also be included within the scope of computer-readable media. Computer-executable instructions comprise, for example, instructions and content which cause a general purpose computer, special purpose computer, special purpose processing device, such as link analyzers and multi-link protocol analyzers, or computing device to perform a certain function or group of functions.

Although not required, aspects of the invention have been described herein in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for correlating non-translative network segments in a multi-protocol communications system, comprising:
providing at least two connected nodes within a network, wherein a first node is in a non-translative network segment with respect to a second node;
at the first node, generating and injecting a defined network pattern into network traffic and recording precisely the time stamp of the network pattern injection;
at the second node, listening to network traffic, taking a copy of the traffic passing by as a trace, and adding precise time stamp information to the trace;
correlating the generated defined network pattern to the traced traffic; and
from the correlation of the generated defined network pattern to the traced traffic, deriving protocol cause and effect correlation rules.

2. A method as defined in claim 1, further comprising the act, prior to deriving protocol cause and effect correlation rules, of presenting the generated traffic and the traced traffic in a visually comparative manner to a user, aligned based on major features which are pattern matched in the network traffic, to permit the user to make manual adjustments to the alignment.

3. A method as defined in claim 1, wherein the act of correlating the generated defined network pattern to the traced traffic is performed by applying a method selected from the group consisting of: pattern matching, expert systems, numerical analysis, and statistical analysis.

4. A method as defined in claim 1, wherein the protocol cause and effect correlation rules are stored as pattern matching tables in a storage system.

5. A method as defined in claim 1, wherein:
the defined network pattern is injected at a plurality of nodes within the network, the timestamp of each injection being recorded precisely at each point of injection; and
the network traffic passing by each of the plurality of nodes is listened to and copied as a trace, with the trace including precise time stamp information.

6. A method as defined in claim 1, wherein the first node is located in a local area network and the second node is located in a storage area network.

7. A method as defined in claim 1, wherein the defined network pattern is injected as a stream.

8. A method as defined in claim 1, wherein at least one of the nodes is selected from the group consisting of: a computer, a device on a storage network, and an external element of equipment.

9. A method as defined in claim 1, wherein at least one of the nodes comprises a network probe that records traces of network traffic.

10. A method as defined in claim 1, wherein the first node and the second node represent at least two different communication protocols selected from the group consisting of: TCP/IP, Infiniband, Ethernet, Gigabit Ethernet, SONET, Fibre Channel, and PCI Express.

11. A method as defined in claim 1, wherein the defined network pattern corresponds to a specific action performed in a given protocol.

12. A method as defined in claim 1, wherein the acts therein are performed repeatedly with different network patterns to obtain a plurality of protocol cause and effect correlation rules, each rule corresponding to a different specific action performed by a given protocol.

13. A method for correlating non-translative network segments in a multi-protocol communications system, comprising:
providing a plurality of connected nodes within a network, wherein a first node is in a non-translative network segment with respect to a second node;
providing pattern matching data which indicates protocol cause and effect correlation rules;
at each of the plurality of nodes, listening to network traffic, taking a copy, as a trace, of the traffic passing by;
applying a run-time process to the traced traffic using the stored pattern matching data to recognize correlations; and
from the recognized correlations, deriving the causality, in a first network segment, of a network activity that is detected in a second network segment that is non-translative with the first network segment.

14. A method as defined in claim 13, further comprising the act of presenting the generated traffic and the traced traffic in a visually comparative manner to a user, aligned based on major features which are pattern matched in the network traffic, and also with visual indications of the pattern matches discovered.

15. A method as defined in claim 13, further comprising the act of adding precise time stamp information to the trace.

16. A method as defined in claim 13, wherein at least one of the nodes is selected from the group consisting of: a computer, a storage network, and an external element of equipment.

17. A method as defined in claim 13, wherein at least one of the nodes comprises a network probe that records traces of network traffic.

18. A method as defined in claim 13, wherein the first node and the second node represent at least two different communication protocols selected from the group consisting of: TCP/IP, Infiniband, Ethernet, Gigabit Ethernet, SONET, Fibre Channel, and, PCI Express.

19. A computer program product for implementing a method for correlating non-translative network segments in a multi-protocol communications system, the computer program product comprising:
a computer readable medium carrying computer executable instructions for performing the method, wherein the method comprises:
providing at least two connected nodes within a network, wherein a first node is in a non-translative network segment with respect to a second node;
at the first node, generating and injecting a defined network pattern into network traffic and recording precisely the time stamp of the network pattern injection;
at the second node, listening to network traffic, taking a copy of the traffic passing by as a trace, and adding precise time stamp information to the trace;
correlating the generated defined network pattern to the traced traffic; and
from the correlation of the generated defined network pattern to the traced traffic, deriving protocol cause and effect correlation rules.

20. A computer program product for implementing a method for determining causality for network activity across non-translative network segments in a multi-protocol communications system, the computer program product comprising:
a computer readable medium carrying computer executable instructions for performing the method, wherein the method comprises:
providing a plurality of connected nodes within a network, wherein a first node is in a non-translative network segment with respect to a second node;
providing pattern matching data which indicates protocol cause and effect correlation rules;
at each of the plurality of nodes, listening to network traffic, taking a copy, as a trace, of the traffic passing by;
applying a run-time process to the traced traffic using the stored pattern matching tables to recognize correlations; and
from the recognized correlations, deriving the causality, in a first network segment, of a network activity that is detected in a second network segment that is non-translative with the first network segment.
